(19) United States
(12) Patent Application Publication
(10) Pub. No.: US 2015/0165794 A1
(43) Pub. Date: Jun. 18, 2015

(54) PAPER DISCHARGE MECHANISM, AND PRINTER AND TERMINAL DEVICE HAVING THE SAME

(71) Applicant: SHANDONG NEW BEIYANG INFORMATION TECHNOLOGY CO., LTD., Shandong (CN)

(72) Inventors: Zhengmin Zhang, Shandong (CN); Tianxin Jiang, Shandong (CN); Yong Yuan, Shandong (CN); Jigang Zhang, Shandong (CN)

(21) Appl. No.: 14/405,651

(22) PCT Filed: May 22, 2013
(86) PCT No.: PCT/CN2013/076065

§ 371 Date: Dec. 4, 2014

(30) Foreign Application Priority Data
Jun. 5, 2012 (CN) 201210183415.8

(51) Int. Cl. B41J 11/70; B41J 15/04; B65H 35/00

(52) U.S. Cl. CPC B41J 11/70; B65H 35/0006; B41J 15/04

(57) ABSTRACT

A paper discharge mechanism, and a printer and a terminal device having the paper discharge mechanism. The paper discharge mechanism includes a frame, a rotary plate, and a paper tear bar. The rotary plate is provided at one side of a conveying passage of printing paper, one end thereof connected to the frame through a pivot shaft and the other end unsupported, and is forced to rotate along a first direction around the pivot shaft when the printing paper is pulled by an external force. The paper tear bar is fixedly provided in the rotation path of the rotary plate. Wherein, the rotary plate is provided with a gap. When the rotary plate rotates along the first direction, the paper tear bar extends out of the gap and contacts the printing paper to tear the printing paper.

The application claims the priority of Chinese patent application No. 201210183415.8, entitled “Paper Discharge Mechanism, and Printer and Terminal Device Having The Same” filed with the State Intellectual Property Office of the People's Republic of China on Jun. 5, 2012, the entire contents of which are incorporated herein by reference.

### TECHNICAL FIELD OF THE INVENTION

The disclosure relates to the field of printers, and particularly to a paper discharge mechanism, and a printer and a terminal device having the paper discharge mechanism.

### BACKGROUND OF THE INVENTION

Self-service terminal devices have been widely applied in various fields, for example, automated teller machines, and telephone bill self-service enquiry machines etc. The self-service terminal is usually provided with a printing device, for example, the automated teller machine can print a transaction receipt, and the telephone bill self-service enquiry machine can print a telephone bill etc. Currently, a common problem of such self-service terminal devices with a printing function is that if a user pulls the printing paper being printed during a printing process, the printing paper is deviated easily to affect the printing effect and a paper jam will be caused, or the printing paper will be wasted because unused printing paper is pulled out continuously.

To solve the problem, Chinese patent application numbered CN201120122809.3 provides a paper discharge mechanism and a printer using the paper discharge mechanism. As shown in FIG. 1 the printer includes a paper roll 3′, a printing component 4′, an automatic cutter 5′, and a paper discharge mechanism which are provided along a printing paper conveying direction in turn, wherein the paper discharge mechanism is provided at an outlet 6′ of the printer and includes an arc-shaped paper guiding plate 7′, a spring 9′ and a sensor 11′. A convex surface of the arc-shaped guiding plate 7′ is in contact with the printing paper. An end of the arc-shaped guiding plate 7′ is pivotably connected with a frame through a pivot shaft 2′. The spring 9′ is supported between the arc-shaped guiding plate 7′ and the frame, Under the action of the spring 9′, the arc-shaped guiding plate 7′ always has a trend of motion to jack up the printing paper, The sensor 11′ is provided at the outlet 6′ and opposite to a free end of the arc-shaped guiding plate 7′. The printing paper passes through the printing component 4 and the automatic cutter 5′, and then is outputted from the outlet 6′. If the paper is pulled during the printing process, the tightly-pulled printing paper presses the arc-shaped guiding plate 7′ so that the arc-shaped guiding plate 7′ overcomes the elasticity of the spring 9′ to rotate around the pivot shaft 2′. The free end of the arc-shaped guiding plate 7′ triggers the sensor 11′, and the sensor 11′ sends out a corresponding detection signal. A controller of the printer controls the automatic cutter 5′ to cut off the printing paper.

The problem of the solution is that, if the printing paper is pulled during the printing process, it still takes some time to cut off the printing paper by the automatic cutter after the sensor senses that the paper is pulled and sends out the detection signal. Therefore, the action of pulling paper will last for a period of time, and it is still a great possibility that the printing paper is pull to deviate, and the problems of affecting printing effect and paper jam may still exist.

### SUMMARY OF THE INVENTION

The purpose of the disclosure is to provide a highly reliable paper discharge mechanism. The purpose of the disclosure is to further provide a printer and terminal device using the paper discharge mechanism.

In view of this, the disclosure provides a paper discharge mechanise including: a frame; a rotary plate, provided at a side of a conveying passage of printing paper, one end thereof connected to the frame through a pivot shaft, the other end unsupported, and forced to rotate in a first direction around the pivot shaft when the printing paper is pulled by an external force; and a paper tear bar, fixedly provided in a rotation path of the rotary plate; wherein the rotary plate is provided with a gap; when the rotary plate rotates in the first direction, the paper tear bar extends out of the gap and contacts the printing paper to tear the printing paper.

Further, the paper tear bar is flake-shaped, and includes a body of the tear bar capable of extending out of the gap, and a fixing part for installing the body of the tear bar.

Further, a blade of the body of the tear bar in contact with the printing paper is tooth-shaped, straight line-shaped, or inverted V-shaped.

Further, the cross section of the rotary plate along a conveying direction of the printing paper is arch-shaped, and arched towards the conveying passage.

Further, the gap is located at the top of the arch of the rotary plate, or close to the top of the arch of the rotary plate.

Further, the paper discharge mechanism further includes a passage plate provided opposite to the rotary plate; the conveying passage is formed between the rotary plate and the passage plate.

Further, the rotary plate and the passage plate are configured obliquely relative to a horizontal direction, wherein the rotary plate is located at an upper side or a lower side of the passage plate.

Further, the paper discharge mechanism further includes an elastic element driving the rotary plate to rotate along a second direction opposite to the first direction.

Further, the paper discharge mechanism further includes a conveying roller set provided on the frame and conveying the printing paper to the conveying passage.

According to another aspect of the disclosure, it is provided that a printer includes a printing device, and the above mentioned paper discharge mechanism connected to a paper outlet of the printing device.

The disclosure further provides a terminal device, including a terminal main body, a printing device provided in the terminal main body, and the above mentioned paper discharge mechanism connected to a paper outlet of the printing device.

The paper discharge mechanism provided by the disclosure includes the rotary plate and the paper tear bar. If the printing paper is pulled artificially during the printing process, the printing paper being pulled will drive the rotary plate to rotate so that the paper tear bar extends out of the gap on the rotary plate to contact the printing paper, and the printing paper is torn immediately.

With regard to the paper discharge mechanism provided by the disclosure, since the printing paper can be torn immediately when pulled, the printing paper to be printed subsequently will not be pulled to deviate, thus avoiding problems, such as affecting printing effect and paper jam etc., caused by the reason that the printing paper is pulled to deviate. Therefore, the paper discharge mechanism provided by the disclosure is highly reliable.

Besides the above-mentioned purposes, features and advantages, other purposes, other features and advantages of the disclosure will be further described in details with reference to the accompanying drawings.

### BRIEF DESCRIPTION OF THE DRAWINGS

The accompanying drawings, which form one part of the specification and are used for further understanding the disclosure, show preferred embodiments of the disclosure and are used for describing the principle of the disclosure with the specification. In the drawings:

FIG. 1 is a structural view of a paper discharge mechanism and a printer using the paper discharge mechanism in the prior art;

FIG. 2 is a schematic view of an embodiment of a terminal device provided by the disclosure;

FIG. 3 is a structure sectional view of the first embodiment of a paper discharge mechanism provided by the disclosure;

FIG. 4 is a structural view of a rotary plate of the first embodiment of a paper discharge mechanism provided by the disclosure;

FIG. 5a is a structural view of a paper tear bar of the first embodiment of a paper discharge mechanism provided by the disclosure;

FIG. 5b is a structural view of a paper tear bar of the second embodiment. of a paper discharge mechanism provided by the disclosure;

FIG. 5c is a structural view of a paper tear bar of the third embodiment of a paper discharge mechanism provided by the disclosure;

FIG. 6 is a structure sectional view of the fourth embodiment of a paper discharge mechanism provided by the disclosure;

FIG. 7 is a structure sectional view of the fifth embodiment of a paper discharge mechanism provided by the disclosure; and

FIG. 8 is a structure sectional view of the sixth embodiment of a paper discharge mechanism provided by the disclosure.

### REFERENCE NUMERALS

100. terminal main body
200. printing device
300. paper discharge mechanism
210. first paper outlet
110. second paper outlet
1. rotary plate
2. passage plate
3. elastic element
4. paper tear bar
5. conveying roller set
8. frame
81. paper inlet
82. paper outlet
11. pivot shaft
12. gap
41. body of the tear bar
42. fixing part
51 driving roller
52. driven roller

### DETAILED DESCRIPTION OF THE INVENTION

The embodiments of the disclosure will be described in details below with reference to the accompanying drawings, but the disclosure may be implemented in various different ways defined and covered by the claims.

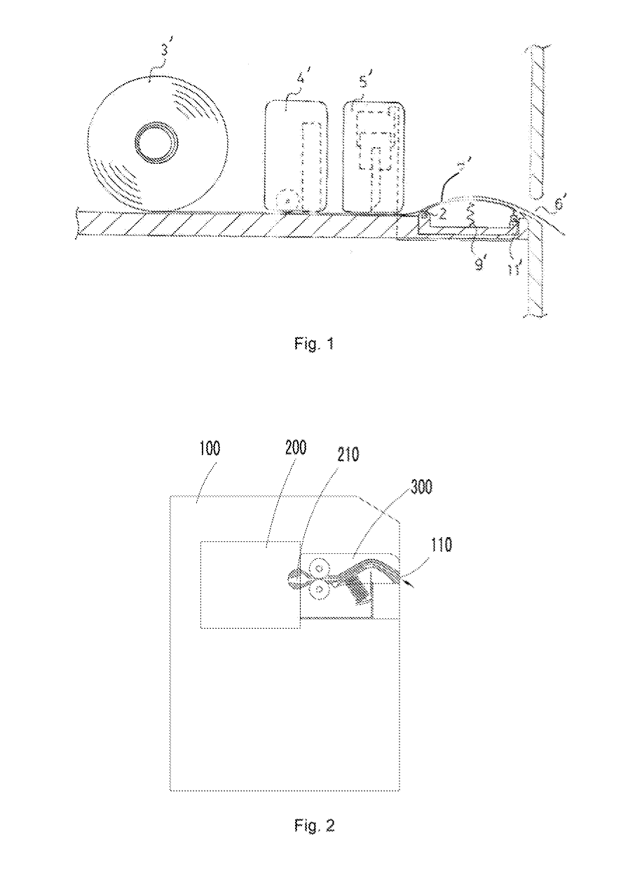

FIG. 2 is a schematic view of an embodiment of a terminal device provided by the disclosure. As shown in FIG. 2, the terminal device includes a terminal main body 100, a printing device 200, and a paper discharge mechanism 300. The printing device 200 is provided in the terminal main body 100. The printing device 200 is provided with a first paper outlet 210 for outputting the printing paper printed from the printing device 200. The terminal main body 100 is provided with a second paper outlet 110 for discharging the printing paper out of the terminal device. The paper discharge mechanism 300, for connecting the first paper outlet 210 and the second paper outlet 110 to form a paper conveying passage for conveying the printing paper, is located between the first paper outlet 210 and the second paper outlet 110.

The terminal device may be a self-service terminal device such as an automated teller machine and a telephone bill self-service enquiry machine etc., and a device such as a Point of Sale (POS) printer, a fiscal cash register, and a lottery machine etc.

The printing device 200 could be a thermal printing device, and could be also an impact printing device or an ink-jet printing device, and a laser printing device. Since the setting manner of traditional printing devices, such as impact printing devices, ink-jet printing devices and laser printing devices etc., are known well by those skilled in the art, they will not be repeated here.

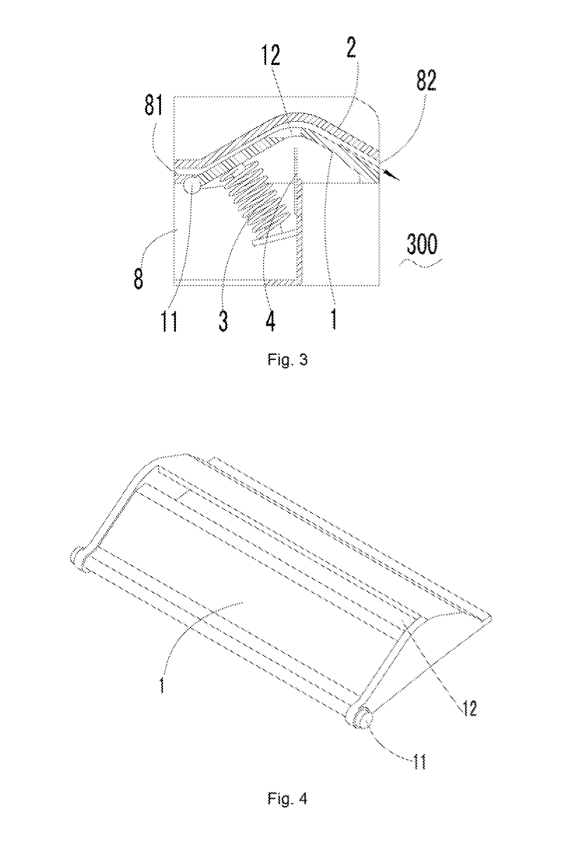

FIG. 3 is a structure sectional view of the first embodiment of a paper discharge mechanism provided by the disclosure. As shown in FIG. 3, the paper discharge mechanism 300 includes a frame 8, a rotary plate 1, a passage plate 2, a paper tear bar 4, and an elastic element 3.

The rotary plate 1 and the passage plate 2 are connected with the frame 8 respectively, and the rotary plate 1 and the passage plate 2 are provided oppositely at a certain interval. A paper conveying passage for conveying paper is formed between the rotary plate 1 and the passage plate 2. One end of the paper conveying passage is a paper inlet 81 of the paper discharge mechanism 300, and the other end is a paper outlet 82 of the paper discharge mechanism 300, wherein the paper inlet 81 is connected with the first paper outlet 210 of the printing device 200, and the paper outlet 82 is connected with the second paper outlet 110 of the terminal main body 100.

Specifically, the passage plate 2 is fixedly connected with the frame 8. One end of the rotary plate 1 is pivotably connected with the frame 8 through a pivot shaft 11 and the other end is unsupported. The rotary plate 1 may rotate around the pivot shaft 11 in a first direction (the clockwise direction as shown in FIG. 3) and has an initial position and an end position. In the embodiment, one end of the rotary plate 1 close to the paper inlet 81 is pivotably connected with the frame 8 through the pivot shaft 11.

A gap 12 is provided on the rotary plate 1. The length of the gap 12 is matched with the width of the printing paper. Along the printing paper conveying direction, the section shape of the rotary plate 1 may be arch-shaped or flat plate-shaped etc. The section shape of the passage plate 2 is matched with that of the rotary plate 1.

FIG. 4 is a structural view of a rotary plate of the first embodiment of a paper discharge mechanism provided by the disclosure. As shown in FIG. 3 and FIG. 4, in the present embodiment, along the printing paper conveying direction, the section shape of the rotary plate 1 is arch-shaped, and the top of the arch of the rotary plate 1 is arched towards the conveying passage, i.e. arched towards the passage plate 2. The gap 12 is provided at the top of the arch of the rotary plate 1 or dose to the top of the arch. Accordingly, an arched concave part matched with the arch of the rotary plate 1 is provided on the passage plate 2.

One end of the elastic element 3 is connected with the frame 8, and the other end is connected with the rotary plate 1. Under the action of the elastic element 3, the rotary plate 1 always has a trend of motion to rotate around the pivot shaft 11 in a second direction (towards the direction close to the passage plate 2) opposite to the first direction.

The paper tear bar 4 is flake-shaped, and includes a body of the tear bar 41 and a fixing part 42, wherein along a length direction of the paper tear bar 4, a blade of the body of the tear bar 41 facing the printing paper may be in a straight line shape, an inverted V shape, or a saw tooth shape etc. When the printing paper contacts the body of the tear bar 41 and is pulled along a direction in which an included angle is formed with the body of the tear bar 41, the body of the tear bar 41 can tear the printing paper. The fixing part 42 may be a structure, such as a fixing hole, a fixing pillar, a clamping hook etc., for connecting with the frame 8 fixedly. After the paper tear bar 4 is fixedly connected with the frame 8, the body of the tear bar 41 is vertical to the printing paper conveying direction, and opposite to the gap 12 on the rotary plate 1.

When the printing paper is moving in the paper discharge mechanism and free from outside interference, the rotary plate 1 is located on the initial position under the action of the elastic element 3. The position of the rotary plate 1 is limited by a limiting part (not shown in the figures) provided on the frame 8. The rotary plate 1 and the passage plate 2 are parallel relatively and provided at a preset interval. At the moment, the body of the tear bar 41 is located outside the paper conveying passage and will not affect the conveyance of the printing paper in the paper conveying passage. When the printing paper is moving in the paper discharge mechanism and is pulled artificially, the rotary plate 1 is rotated around the pivot shaft 11 in the first direction by an external force to overcome the elasticity of the elastic element 3. When the rotary plate 1 rotates towards a direction away from the passage plate 2 to the end position, the body of the tear bar 41 extends from the gap 12 on the rotary plate 1 into the paper conveying passage to contact the printing paper at the moment.

In the embodiment, along the length direction of the paper tear bar 4, the blade of the tear bar 41 is of an inverted V shape. Preferably, the top of the V shape is located on the center of the length of the paper tear bar 4. When the printing paper is pulled, the top of the body of the tear bar 41 is in point contact with the printing paper first to penetrate the printing paper, and then two blades of the V shape can tear the printing paper easily.

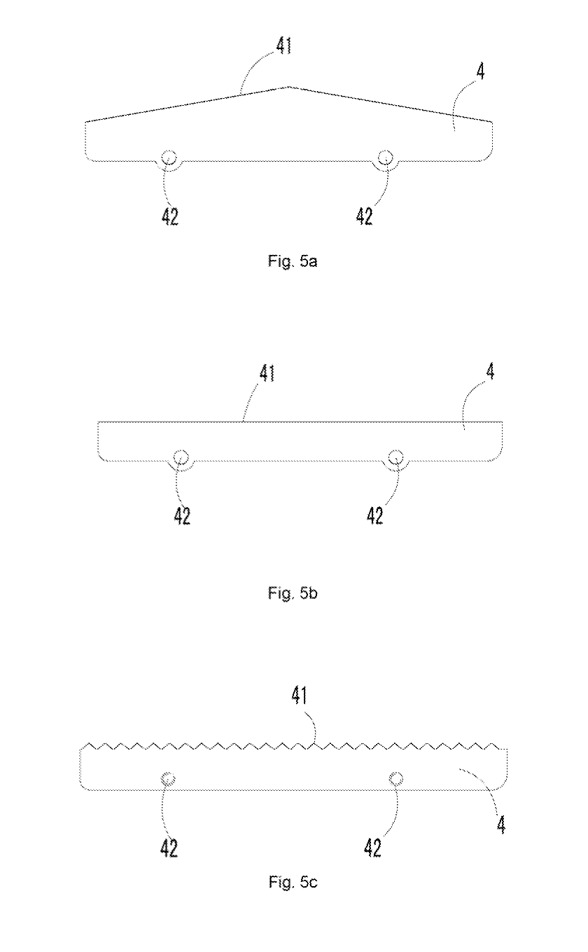

In other embodiments of the paper discharge mechanism provided by the disclosure, the body of the tear bar 41 may be in other structural forms. As shown in FIG. 5b, in the present embodiment, the body of the tear bar 41 is a straight line-shaped blade. When the printing paper is in contact with the body of the tear bar and pulled towards a direction in which an included angle is formed with the body of the tear bar 41, the body of the tear bar 41 can tear the printing paper. As shown in FIG. 5c, in the present embodiment, the blade of the paper tear bar 4 is in a saw tooth shape. When the printing paper is in contact with the body of the tear bar 41 and pulled towards a direction in which an included angle is formed with the body of the tear bar 41, the printing paper can be also torn.

The working principle of the paper discharge mechanism provided by the disclosure will be introduced below.

During the printing process, the printing paper is discharged from the first paper outlet 210 of the printing device and enters the paper conveying passage of the paper discharge mechanism 300 from the paper inlet 81 of the paper discharge mechanism. When the printing paper is moving in the paper discharge mechanism and free from outside interference, the rotary plate 1 is located on the initial position under the action of the elastic element 3, the body of the tear bar 41 is located outside the paper conveying passage, and will not affect the conveyance of the printing paper in the paper conveying passage. When the printing paper is pulled artificially during the conveying process, the printing paper which is straightened by being pulled presses the rotary plate 1 so that the rotary plate 1 overcomes the elasticity of the elastic element 3 and rotates from the initial position to the end position. The body of the tear bar 41 extends out the gap 12 on the rotary plate 1 to contact the straightened printing paper and the printing paper is torn by the body of the tear bar 41.

The paper discharge mechanism provided by the disclosure includes the rotary plate, the elastic element and the paper tear bar. When the printing paper is pulled artificially during the printing paper outputting process, the printing paper drives the rotary plate to rotate so that the edge body of the paper tear bar extends out the gap on the rotary plate and contacts the printing paper. Thus the printing paper is torn at the blade of the paper tear bar. With regard to the paper discharge mechanism provided by the disclosure, since the printing paper can be torn immediately when be pulled, the printing paper to be printed subsequently will not be pulled to deviate, thus avoiding problems, such as affecting printing effect and paper jam etc., caused by the reason that the printing paper is pulled to deviate. Therefore, the paper discharge mechanism provided by the disclosure is highly reliable.

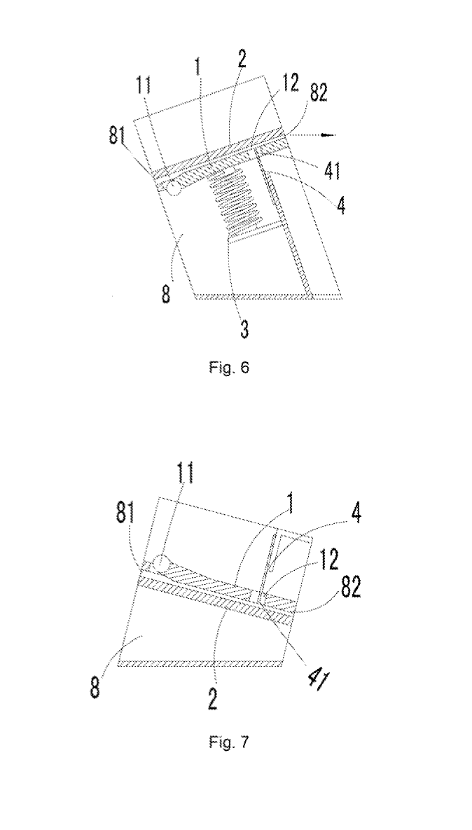

FIG. 6 is a structure sectional view of the fourth embodiment of a paper discharge mechanism provided by the disclosure. Compared with the embodiments above, the difference is that the rotary plate 1 in the present embodiment is a flat plate; the paper conveying passage extends upwards obliquely and is provided with an included angle with the horizontal direction.

As shown in FIG. 6, both the rotary plate 1 and the passage plate 2 are in flat plate-shape, both of them extend upwards obliquely, are provided with an included angle with the horizontal direction, and are provided in parallel at a preset interval to form a paper conveying passage extending upwards obliquely. The gap 12 on the rotary plate 1 are provided dose to a free end of the rotary plate 1.

During the conveyance of the printing paper in the paper discharge mechanism 300, if the printing paper is pulled artificially while being printed, the printing paper being straightened by being pulled presses the rotary plate 1 provided obliquely so that the rotary plate rotates along the first direction, thus the body of the tear bar 41 extends out the gap 12 on the rotary plate 1 to contact the straightened printing paper, and the printing paper is torn.

FIG. 7 is a structure sectional view of the fifth embodiment of a paper discharge mechanism provided by the disclosure. As shown in FIG. 7, compared with the embodiments above, the difference is that the paper discharge mechanism in the present embodiment does not include the elastic element 3, the paper conveying passage extends obliquely downwards. The rotary plate 1 is located above the passage plate 2, and always has a trend of motion to rotate towards the passage plate 2 under the action of its own gravity thereof.

If the printing paper being printed is pulled artificially, the printing paper being straightened by pulling presses the rotary plate 1 provided obliquely so that the rotary plate 1 overcomes its own gravity thereof to rotate along the first direction to move from the initial position to the end position, thus body of the tear bar 41 extends out the gap 12 on the rotary plate 1 to contact the straightened printing paper and tear the printing paper. Compared with the previous embodiment, the present embodiment reduces the number of parts, thus further reducing the device cost.

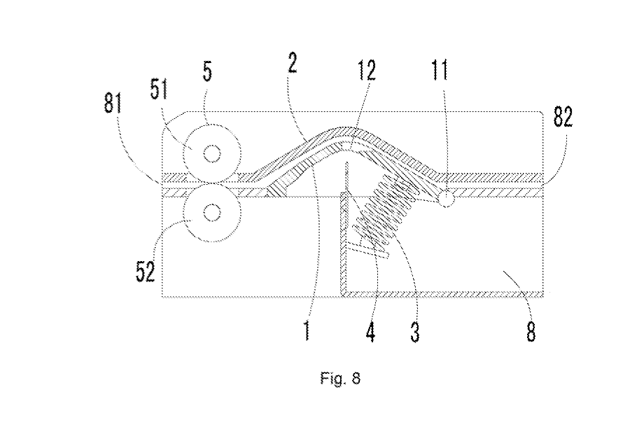

FIG. 8 is a structure sectional view of the sixth embodiment of a paper discharge mechanism provided by the disclosure. As shown in FIG. 8, compared with the first embodiment, the difference is that the paper discharge mechanism 300 in the present embodiment further includes a conveying roller set 5. Along the conveying direction of the printing paper, the conveying roller set 5 is located upstream the rotary plate 1 for discharging the printing paper entering the paper discharge mechanism 30 via the rotary plate 1. In addition, one end of the rotary plate 1 close to the paper outlet 82 is pivotably connected with the frame 8 through the pivot shaft 11.

The conveying roller set 5 includes a driving roller 51 and a driven roller 52 which are provided oppositely. The driving roller 51 and the driven roller 52 are located at two sides of the paper conveying passage respectively, and the axes of both are parallel to the width direction of the printing paper, and both of them can rotate freely about the axes thereof. Wherein the driving roller 51 is in transmission connection with a driving mechanism (not shown in the figures). When the driving mechanism drives the driving roller 51 to rotate, the printing paper between the driving roller 51 and the driven roller 52 can be driven to be discharged from the paper outlet 82 of the paper discharge mechanism 300 via the rotary plate 1.

During the conveyance of the printing paper in the paper discharge mechanism 300, if the printing paper being printed is pulled artificially, the printing paper being straightened by pulling presses the top of the arch of the rotary plate 1 so that the rotary plate 1 rotates from the initial position to the end position along the first direction, thus the body of the tear bar 41 extends out the gap 12 on the rotary plate 1 to contact the straightened printing paper and the printing paper is torn.

In the present embodiment, by providing the conveying roller set 5 at the paper discharge mechanism 300, it could hinder to artificially pull the printing paper being conveyed, and reduce the influence of pulling action of the printing paper on the printing mechanism.

The above are only preferred embodiments of the disclosure and are not used for limiting the disclosure, For persons skilled in the art, the disclosure may have various alternations and changes. Any modifications, equivalent replacements, improvements and the like within the spirit and principle of the disclosure should be contained within the protection scope of the disclosure.

1. A paper discharge mechanism comprising:
a frame (8);
a rotary plate (1), provided at a side of a conveying passage of printing paper, one end thereof connected to the frame (8) through a pivot shaft 11), the other end unsupported, and forced to rotate in a first direction around the pivot shaft (11) when the printing paper is pulled by an external force and
a paper tear bar (4), fixedly provided in a rotation path of the rotary plate (1);
wherein the rotary plate Cl) is provided with a. gap (12); when the rotary plate (I) rotates in the first direction, the paper tear bar (4) extends out of the gap (12) and contacts the printing paper to tear the printing paper.

2. The paper discharge mechanism according to claim 1, wherein the paper tear bar (4) is flake-shaped, and comprises a body of the tear bar (41) capable of extending out of the gap (12), and a fixing part (42) for installing the body of the tear bar (41),

3. The paper discharge mechanism according to claim 2, wherein a blade of the body of the tear bar (41) in contact with the printing paper is tooth-shaped, straight line-shaped, or inverted V-shaped.

4. The paper discharge mechanism according to claim 1, wherein the cross section of the rotary plate (1) along a conveying direction of the printing paper is arch-shaped, and arched towards the conveying passage.

5. The paper discharge mechanism according to claim 4, wherein the gap (12) is located at the top of the arch of the rotary plate (1), or close to the top of the arch of the rotary plate (1).

6. The paper discharge mechanism according to claim 1, further comprising a passage plate (2) provided opposite to the rotary plate (1); the conveying passage is formed between the rotary plate (1) and the passage plate (2).

7. The paper discharge mechanism according to claim 6, wherein the rotary plate (1) and the passage plate (2) are configured obliquely relative to a horizontal direction, wherein the rotary plate (1) is located at an upper side or a lower side of the passage plate (2).

8. The paper discharge mechanism according to claim 1, further comprising an elastic element (3) driving the rotary plate (1) to rotate along a second direction opposite to the first direction.

9. The paper discharge mechanism according to claim 1, further comprising a conveying roller set (5) provided on the frame (8) and conveying the printing paper to the conveying passage.

10. A printer, comprising a printing device (200), and a paper discharge mechanism (300) connected to a paper outlet (210) of the printing device (200), wherein the paper discharge mechanism (300) is the paper discharge mechanism according to claim 1.

11. A terminal device, comprising a terminal main body (100), a printing device (200) provided in the terminal main body (100), and a paper discharge mechanism (300) connected to a paper outlet (210) of the printing device (200), wherein the paper discharge mechanism (300) is the paper discharge mechanism according, to any one of claim 1.

12. The printer according to claim 10, wherein the paper tear bar (4) is flake-shaped, and comprises a body of the tear bar (41) capable of extending out of the gap (12), and a fixing part (42) for installing the body of the tear bar (41),

13. The printer according to claim 12, wherein a blade of the body of the tear bar (41) in contact with the printing paper is tooth-shaped, straight line-shaped, or inverted V-shaped.

14. The printer according to claim 10, wherein the cross section of the rotary plate (1) along a conveying direction of the printing paper is arch-shaped, and arched towards the conveying passage.

15. The printer according to claim 14, wherein the gap (12) is located at the top of the arch of the rotary plate (1), or close to the top of the arch of the rotary plate (1).

16. The printer according to claim 10, further comprising a passage plate (2) provided opposite to the rotary plate (1); the conveying passage is formed between the rotary plate (1) and the passage plate (2).

17. The printer according to claim 16, wherein the rotary plate (1) and the passage plate (2) are configured obliquely relative to a horizontal direction, wherein the rotary plate (1) is located at an upper side or a lower side of the passage plate (2).

18. The printer according to claim 10, further comprising an elastic element (3) driving the rotary plate (1) to rotate along a second direction opposite to the first direction.

19. The printer according to claim 10, further comprising a conveying roller set (5) provided on the frame (8) and conveying the printing paper to the conveying passage.
